(19) United States
(12) Patent Application Publication
(10) Pub. No.: US 2026/0149158 A1
(43) Pub. Date: May 28, 2026

(54) CONNECTION STRUCTURE AND WAVEGUIDE

(71) Applicant: Kabushiki Kaisha Toshiba, Tokyo (JP)

(72) Inventor: Ren SHIBATA, Yokohama Kanagawa (JP)

(21) Appl. No.: 19/257,143

(22) Filed: Jul. 1, 2025

(30) Foreign Application Priority Data
Nov. 28, 2024 (JP) 2024-207477

(51) Int. Cl. H01P 3/12

(52) U.S. Cl. CPC H01P 3/121

(57) ABSTRACT

According to one embodiment, a connection structure is configured to be provided between a first resonating portion and a second resonating portion. The connection structure includes a first structure. The first structure includes first and second conductive pillars, a first strip line, and a first partial conductive layer. The first conductive pillar includes a first portion and a first other portion, the first conductive pillar being along a first direction. The second conductive pillar includes a second portion and a second other portion, the second conductive pillar being along the first direction. The first strip line is electrically connected to the first other portion and the second other portion, the first strip line being along the second direction. The first partial conductive layer is electrically connected to the first portion and the second portion.

### CROSS-REFERENCE TO RELATED APPLICATIONS

This application is based upon and claims the benefit of priority from Japanese Patent Application No. 2024-207477, filed on Nov. 28, 2024; the entire contents of which are incorporated herein by reference.

### FIELD

Embodiments described herein relate generally to a connection structure and a waveguide.

### BACKGROUND

For example, connection structures and waveguide are used in radio-frequency circuits. There is a demand for improved characteristics in connection structures and waveguides.

### BRIEF DESCRIPTION OF THE DRAWINGS

FIG. 1 is a schematic transparent perspective view illustrating a connection structure according to a first embodiment;

FIG. 2 is a schematic transparent plan view illustrating the connection structure according to the first embodiment;

FIG. 3 is a schematic transparent side view illustrating the connection structure according to the first embodiment;

FIG. 4 is a schematic cross-sectional view illustrating the connection structure according to the first embodiment;

FIG. 5 is a schematic transparent perspective view illustrating the connection structure;

FIG. 6 is a schematic diagram illustrating the results of a simulation;

FIG. 7 is a schematic diagram illustrating the results of the simulation;

FIG. 8 is a schematic diagram illustrating the results of the simulation;

FIG. 9 is a schematic diagram illustrating the results of the simulation;

FIG. 10 is a schematic transparent perspective view illustrating a connection structure according to the first embodiment;

FIG. 11 is a schematic transparent plan view illustrating the connection structure according to the first embodiment;

FIG. 12 is a schematic transparent side view illustrating the connection structure according to the first embodiment;

FIG. 13 is a schematic cross-sectional view illustrating the connection structure according to the first embodiment;

FIG. 14 is a schematic transparent plan view illustrating a connection structure of a reference example;

FIG. 15 is a graph illustrating the characteristics of the connection structure of the reference example;

FIG. 16 is a schematic transparent plan view illustrating the connection structure;

FIG. 17 is a schematic transparent plan view illustrating the connection structure;

FIG. 18 is a graph illustrating the characteristics of the connection structure according to the first embodiment;

FIG. 19 is a graph illustrating the characteristics of the connection structure according to the first embodiment;

FIG. 20 is a schematic cross-sectional view illustrating a connection structure according to the first embodiment;

FIG. 21 is a schematic cross-sectional view illustrating a connection structure according to the first embodiment;

FIG. 22 is a schematic cross-sectional view illustrating a connection structure according to the first embodiment;

FIG. 23 is a schematic transparent plan view illustrating a connection structure according to a second embodiment;

FIG. 24 is a schematic cross-sectional view illustrating the connection structure according to the second embodiment;

FIG. 25 is a schematic cross-sectional view illustrating a connection structure according to the second embodiment;

FIG. 26 is a schematic cross-sectional view illustrating a connection structure according to the second embodiment;

FIG. 27 is a schematic cross-sectional view illustrating a connection structure according to the second embodiment;

FIG. 28 is a schematic cross-sectional view illustrating a connection structure according to the second embodiment;

FIG. 29 is a schematic view illustrating a waveguide of a reference example;

FIG. 30 is a schematic view illustrating the waveguide of the reference example;

FIG. 31 is a schematic view illustrating the waveguide of the reference example;

FIG. 32 is a schematic diagram illustrating a resonator of the reference example;

FIG. 33 is a schematic diagram illustrating the characteristics of the resonator of the reference example; and

FIG. 34 is a schematic transparent plan view illustrating a waveguide of a reference example.

### DETAILED DESCRIPTION

According to one embodiment, a connection structure is configured to be provided between a first resonating portion and a second resonating portion. The connection structure includes a first structure. The first structure includes a first conductive pillar, a second conductive pillar, a first strip line, and a first partial conductive layer. The first conductive pillar includes a first portion and a first other portion, the first conductive pillar being along a first direction. A direction from the first portion to the first other portion is along the first direction. The second conductive pillar includes a second portion and a second other portion, the second conductive pillar being along the first direction. A direction from the second portion to the second other portion is along the first direction. A second direction from the second conductive pillar to the first conductive pillar crosses the first direction. A direction from the first resonating portion to the second resonating portion is along the second direction. The first strip line is electrically connected to the first other portion and the second other portion, the first strip line being along the second direction. The first partial conductive layer is electrically connected to the first portion and the second portion.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

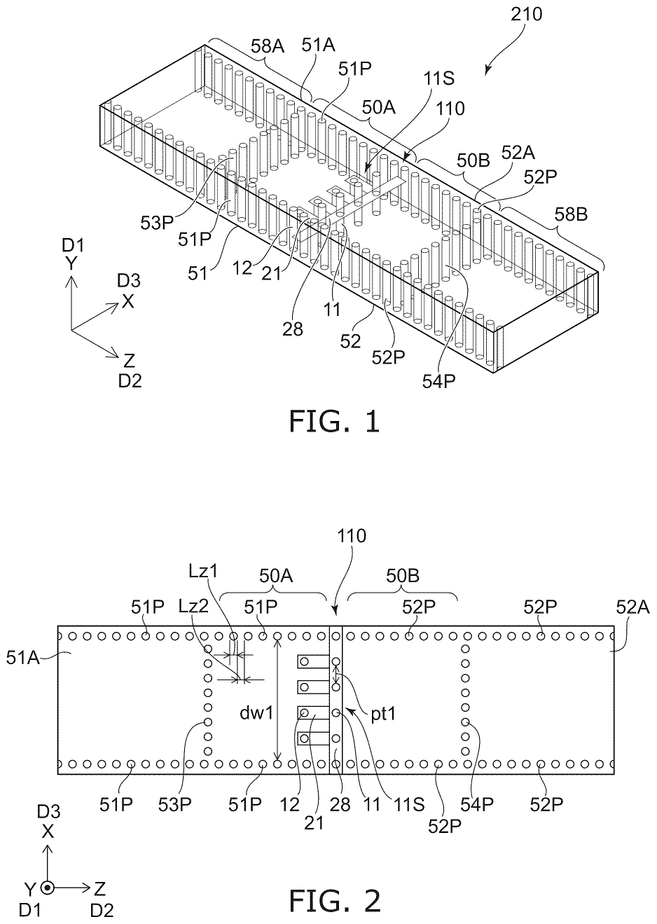

FIG. 1 is a schematic transparent perspective view illustrating a connection structure according to a first embodiment.

FIG. 2 is a schematic transparent plan view illustrating the connection structure according to the first embodiment.

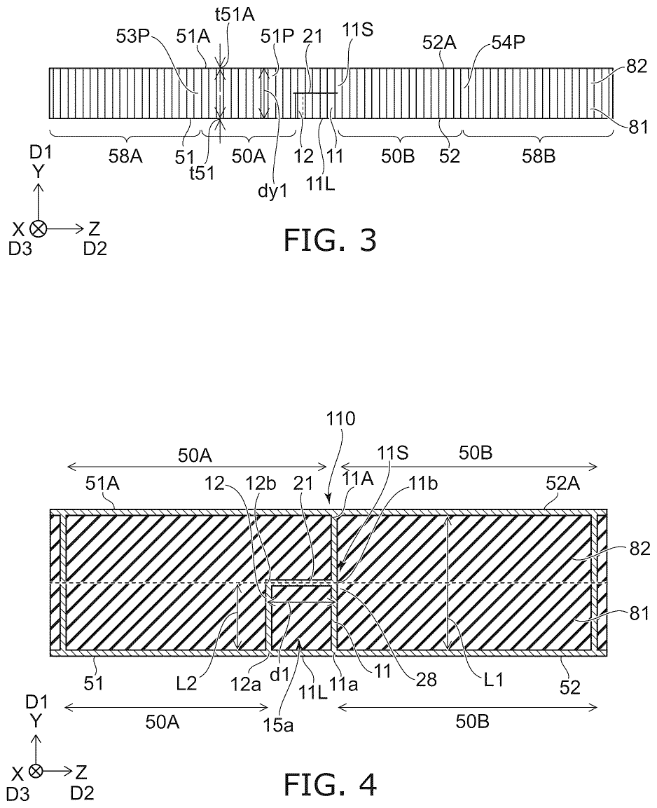

FIG. 3 is a schematic transparent side view illustrating the connection structure according to the first embodiment.

FIG. 4 is a schematic cross-sectional view illustrating the connection structure according to the first embodiment.

As shown in FIGS. 1 to 4, a connection structure 110 according to the embodiment is provided between a first resonating portion 50A and a second resonating portion 50B.

For example, the first resonating portion 50A is provided between a first waveguide portion 58A and a second waveguide portion 58B. The second resonating portion 50B is provided between the first resonating portion 50A and the second waveguide portion 58B.

The connection structure 110 includes a first structure 11S. The first structure 11S includes a first conductive pillar 11, a second conductive pillar 12, and a first strip line 21. The first structure 11S may further include a first partial conductive layer 11L.

The first conductive pillar 11 is along a first direction D1. The first direction D1 is defined as a Y-axis direction. One direction that crosses the Y-axis direction is defined as a Z-axis direction. A direction perpendicular to the Y-axis direction and the Z-axis direction is defined as an X-axis direction.

A second direction D2 from the second conductive pillar 12 to the first conductive pillar 11 crosses the first direction D1. The second direction D2 may be, for example, the Z-axis direction. A direction from the first resonating portion 50A to the second resonating portion 50B is along the second direction D2.

In one example, a signal (e.g., an electromagnetic wave) supplied to the first waveguide portion 58A propagates to the second waveguide portion 58B via the first resonating portion 50A, the connection structure 110, and the second resonating portion 50B.

As shown in FIG. 4, the first conductive pillar 11 includes a first portion 11a and a first other portion 11b. A direction from the first portion 11a to the first other portion 11b is along the first direction D1. In this example, the first conductive pillar 11 includes a first opposing portion 11A. The first other portion 11b is between the first portion 11a and the first opposing portion 11A in the first direction D1.

The second conductive pillar 12 includes a second portion 12a and a second other portion 12b. The second conductive pillar 12 is along the first direction D1. A direction from the second portion 12a to the second other portion 12b is along the first direction D1.

The first strip line 21 is electrically connected to the first other portion 11b and the second other portion 12b. The first strip line 21 is along the second direction D2. The first partial conductive layer 11L is electrically connected to the first portion 11a and the second portion 12a.

For example, a first conductive loop 15a is formed by a part of the first conductive pillar 11, the first strip line 21, the second conductive pillar 12, and the first partial conductive layer 11L. The part of the first conductive pillar 11 is a part between the first portion 11a and the first other portion 11b. In the first conductive loop 15a, for example, a magnetic field in the connection structure 110 is cancelled. This makes it possible to connect the first resonating portion 50A and the second resonating portion 50B while suppressing coupling between the first resonating portion 50A and the second resonating portion 50B.

For example, in a resonator having an SIW (substrate integrated waveguide) structure, a reference example can be considered in which the number of a conductive pillar array provided in a connecting portion is increased in order to suppress coupling between plurality of resonating portions. In this reference example, the number of the conductive pillar array increases, so the overall size of the circuit increases. In particular, in radio-frequency circuit applications, the distance between two conductive layers included in the SIW structure is increased in order to reduce loss. When the distance between the two conductive layers is increased, the conductive pillar connecting them becomes longer. In a case where the conductive pillar is thin, manufacturing becomes difficult. Using a thick conductive pillar makes manufacturing easier, but the size increases.

In the embodiment, a part of the first conductive pillar 11, the first strip line 21, the second conductive pillar 12, and the first partial conductive layer 11L are provided, which are electrically connected to each other. This cancels out the magnetic field in the connection structure 110. The first resonating portion 50A and the second resonating portion 50B are connected together with a simple structure while suppressing coupling between the first resonating portion 50A and the second resonating portion 50B. According to the embodiment, a connection structure capable of improving characteristics can be provided.

In the embodiment, coupling can be suppressed while suppressing an increase in the size of the circuit. The connection structure 110 according to the embodiment can be applied to a radio-frequency circuit. For example, coupling can be suppressed while suppressing loss. According to the embodiment, a connection structure capable of improving characteristics can be provided.

Thus, the connection structure 110 is provided between the first resonating portion 50A and the second resonating portion 50B. The connection structure 110 includes the first structure 11S including the first conductive loop 15a. The first conductive loop 15a is along the first direction D1 and the second direction D2 crossing the first direction D1. The direction from the first resonating portion 50A to the second resonating portion 50B is along the second direction D2.

As shown in FIG. 1, the first resonating portion 50A may include a first conductive layer 51, a first opposing conductive layer 51A, and a plurality of first resonating portion conductive pillars 51P. A direction from the first conductive layer 51 to the first opposing conductive layer 51A is along the first direction D1. The plurality of first resonating portion conductive pillars 51P electrically connect the first opposing conductive layer 51A to the first conductive layer 51.

The second resonating portion 50B includes a second conductive layer 52, a second opposing conductive layer 52A, and a plurality of second resonating portion conductive pillars 52P. A direction from the second conductive layer 52 to the second opposing conductive layer 52A is along the first direction D1. The plurality of second resonating portion conductive pillars 52P electrically connect the second opposing conductive layer 52A to the second conductive layer 52.

A part of the plurality of first resonating portion conductive pillars 51P is arranged along the second direction D2. Another part of the plurality of first resonating portion conductive pillars 51P is arranged along the second direction D2. A direction from the part of the plurality of first resonating portion conductive pillars 51P to the other part of the plurality of first resonating portion conductive pillars 51P is along a third direction D3. The third direction D3 crosses a plane including the first direction D1 and the second direction D2. The third direction D3 may be, for example, the X-axis direction.

For example, the second conductive layer 52 may be configured to be electrically connected to the first conductive layer 51. The second opposing conductive layer 52A may be configured to be electrically connected to the first opposing conductive layer 51A. The second opposing conductive layer 52A may be continuous with the first opposing conductive layer 51A. The boundary between the second opposing conductive layer 52A and the first opposing conductive layer 51A may be unclear.

As shown in FIGS. 3 and 4, for example, the first partial conductive layer 11L may be configured to be continuous with the first conductive layer 51. The boundary between the first partial conductive layer 11L and the first conductive layer 51 may be unclear. The first partial conductive layer 11L may be configured to be continuous with the second conductive layer 52. The boundary between the first partial conductive layer 11L and the second conductive layer 52 may be unclear. Thus, the first partial conductive layer 11L may be electrically connected to the first conductive layer 51 included in the first resonating portion 50A. The first partial conductive layer 11L may be electrically connected to the second conductive layer 52 included in the second resonating portion 50B.

As shown in FIG. 4, for example, a first base 81 and a second base 82 may be provided. A first conductive film that becomes the first conductive layer 51, the first partial conductive layer 11L, and the second conductive layer 52 may be provided on one face of the first base 81. A second conductive film that becomes the first opposing conductive layer 51A and the second opposing conductive layer 52A may be provided on one face of the second base 82.

The first base 81 is provided between the first conductive film and the second base 82. The second base 82 is provided between the first base 81 and the second conductive film. The first strip line 21 is provided between the first base 81 and the second base 82. The first strip line 21 may be provided on the face of one of the first base 81 and the second base 82.

For example, the second conductive pillar 12 penetrates the first base 81 along the first direction D1. The first conductive pillar 11 penetrates the first base 81 and the second base 82 along the first direction D1. For example, the part between the first portion 11a and the first other portion 11b penetrates the first base 81 along the first direction D1. For example, the part between the first other portion 11b and the first opposing portion 11A penetrates the second base 82 along the first direction D1. The part between the first portion 11a and the first other portion 11b and the part between the first other portion 11b and the first opposing portion 11A may be formed separately, and then these portions may be electrically connected.

As shown in FIG. 4, in this example, the first opposing portion 11A is configured to be electrically connected to the first opposing conductive layer 51A. The first opposing portion 11A is configured to be electrically connected to the second opposing conductive layer 52A.

As shown in FIGS. 1 and 2, the plurality of first structures 11S may be provided. The third direction D3 from one of the plurality of first structures 11S to another one of the plurality of first structures 11S crosses a plane including the first direction D1 and the second direction D2.

The connection structure 110 may further include a first connection conductive layer 28. The first connection conductive layer 28 is along the third direction D3. The first connection conductive layer 28 extends along the third direction D3. The first connection conductive layer 28 electrically connects the plurality of first structures 11S.

The plurality of first conductive loops 15a based on the plurality of first structures 11S are arranged along the third direction D3. The magnetic field is effectively cancelled by the plurality of first conductive loops 15a. Coupling is effectively suppressed.

As shown in FIG. 2, a length (width) of one of the plurality of first resonating portion conductive pillars 51P along the second direction D2 is defined as a length Lz1. In one example, the length Lz1 is, for example, not less than 0.1 mm and not more than 1.0 mm (e.g., 0.3 mm). The length Lz1 may be in any direction perpendicular to the first direction D1.

As shown in FIG. 2, a distance between one of the plurality of first resonating portion conductive pillars 51P and another one of the plurality of first resonating portion conductive pillars 51P is defined as a distance Lz2. The one of the plurality of first resonating portion conductive pillars 51P is next to the other one of the plurality of first resonating portion conductive pillars 51P in the second direction D2. In one example, the distance Lz2 is, for example, not less than 0.1 mm and not more than 1.0 mm (for example, 0.3 mm).

As shown in FIG. 2, a distance along the third direction D3 between a row of the plurality of first resonating portion conductive pillars 51P arranged along the second direction D2 and another row of the plurality of first resonating portion conductive pillars 51P arranged along the second direction D2 is defined as a distance dw1. In one example, the distance dw1 is not less than 3 mm and not more than 10.0 mm (for example, 4.99 mm).

The above description of the plurality of first resonating portion conductive pillars 51P may be applied to the plurality of second resonating portion conductive pillars 52P.

As shown in FIG. 3, a thickness of the first conductive layer 51 along the first direction D1 is defined as a first conductive layer thickness t51. The thickness of the first opposing conductive layer 51A along the first direction D1 is defined as a first opposing conductive layer thickness t51A. At least one of the first conductive layer thickness t51 or the first opposing conductive layer thickness t51A may be, for example, not less than 5μm and not more than 50 μm (e.g., 18μm). A distance along the first direction D1 between the first conductive layer thickness t51 and the first opposing conductive layer thickness t51A is defined as a distance dy1. In one example, the distance dy1 is, for example, not less than 0.5 mm not more than 4 mm (e.g., 2 mm).

As shown in FIG. 4, a length of the first conductive pillar 11 in the first direction D1 is defined as a first length L1. The length of the second conductive pillar 12 in the first direction D1 is defined as a second length L2. In this example, the first length L1 is longer than the second length L2. The first length L1 may be, for example, not less than 1.1 times and not more than 3 times the second length L2. In this example, the first length L1 is, for example, substantially twice the second length L2. In one example, the second length L2 is, for example, not less than 0.5 mm and not more than 1.5 mm (for example, 1 mm).

As shown in FIG. 4, a distance in the second direction D2 between a center (first center) of the first conductive pillar 11 in the second direction D2 and a center (second center) of the second conductive pillar 12 in the second direction D2 is defined as a first distance d1. In one example, the first distance d1 may be not less than 0.7 mm and not more than 1.2 mm. A wavelength of the signal propagating through the first resonating portion 50A is defined as a wavelength λ. The first distance d1 may be, for example, not less than 0.07 times and not more than 0.12 times of the wavelength λ. An example of the relationship between the first distance d1 and the characteristics will be described later.

As shown in FIG. 2, a pitch of the plurality of first structures 11S in the third direction D3 is defined as a pitch pt1. The pitch pt1 corresponds to, for example, the distance along the third direction D3 between a center of one of the plurality of first conductive pillars 11 in the third direction D3 and a center of another one of the plurality of first conductive pillars 11 in the third direction D3. The one of the plurality of first conductive pillars 11 is next to the other one of the plurality of first conductive pillars 11. The pitch pt1 may be, for example, not less than 0.3 mm and not more than 1.1 mm. The pitch pt1 may be, for example, 0.11 times or less the wavelength λ of the signal propagating through the first resonating portion 50A. An example of the relationship between the pitch pt1 and the characteristics will be described later.

As shown in FIGS. 1 and 2, the first resonating portion 50A may include a plurality of third resonating portion conductive pillars 53P. The plurality of third resonating portion conductive pillars 53P are arranged along the third direction D3. A position of the plurality of third resonating portion conductive pillars 53P in the second direction D2 is between a position of the first resonating portion conductive pillars 51P included in the first resonating portion 50A in the second direction D2 and a position of the first waveguide portion 58A in the third direction D3.

As shown in FIGS. 1 and 2, the second resonating portion 50B may include a plurality of fourth resonating portion conductive pillars 54P. The plurality of fourth resonating portion conductive pillars 54P are arranged along the third direction D3. The position of the plurality of fourth resonating portion conductive pillars 54P in the second direction D2 is between the position of the second resonating portion conductive pillar 52P included in the second resonating portion 50B in the second direction D2 and a position of the second waveguide portion 58B in the third direction D3.

The first waveguide portion 58A may include a conductive layer continuous with the first conductive layer 51, and a conductive layer continuous with the first opposing conductive layer 51A. The first waveguide portion 58A may include conductive pillars similar to the plurality of first resonating portion conductive pillars 51P included in the first resonating portion 50A.

The second waveguide portion 58B may include a conductive layer continuous with the second conductive layer 52, and a conductive layer continuous with the second opposing conductive layer 52A. The second waveguide portion 58B may include conductive pillars similar to the plurality of second resonating portion conductive pillars 52P included in the second resonating portion 50B.

As shown in FIG. 1, for example, the resonating structure 210 according to the embodiment includes the first resonating portion 50A, the second resonating portion 50B, and the connection structure 110.

Below, an example of simulation results relating to the characteristics of the connection structure 110 will be described.

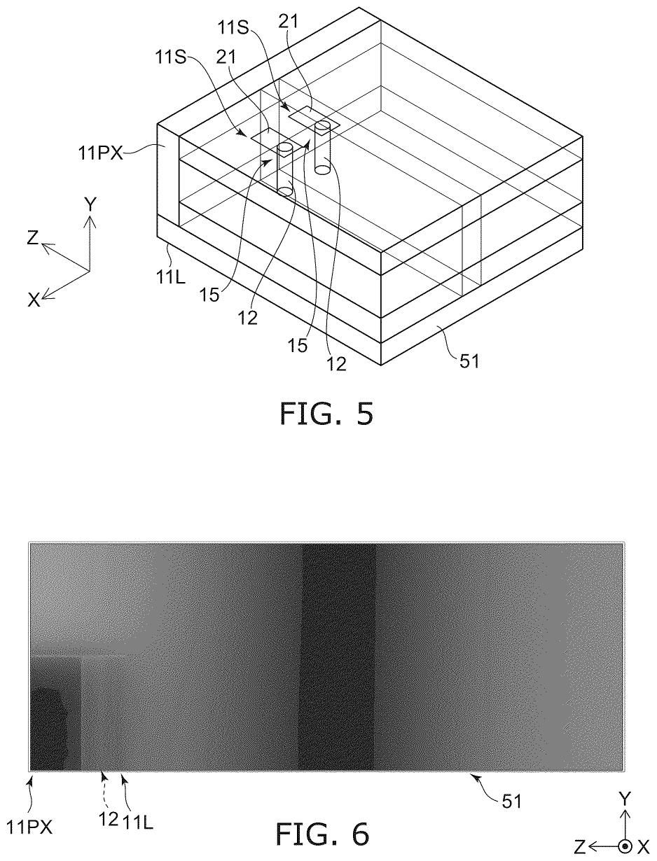

FIG. 5 is a schematic transparent perspective view illustrating the connection structure.

FIG. 5 shows a simulation model. In the simulation model, a conductive layer 11PX is provided in place of the plurality of first conductive pillars 11. The conductive layer 11PX is along the X-Y plane. In the simulation model, two first structures 11S are provided. That is, two second conductive pillars 12 are provided. One of the two second conductive pillars 12 is electrically connected to the conductive layer 11PX by one of the two first strip lines 21. The second conductive pillar 12, the first strip line 21, the conductive layer 11PX, and the first partial conductive layer 11L form one of two first conductive loops 15a.

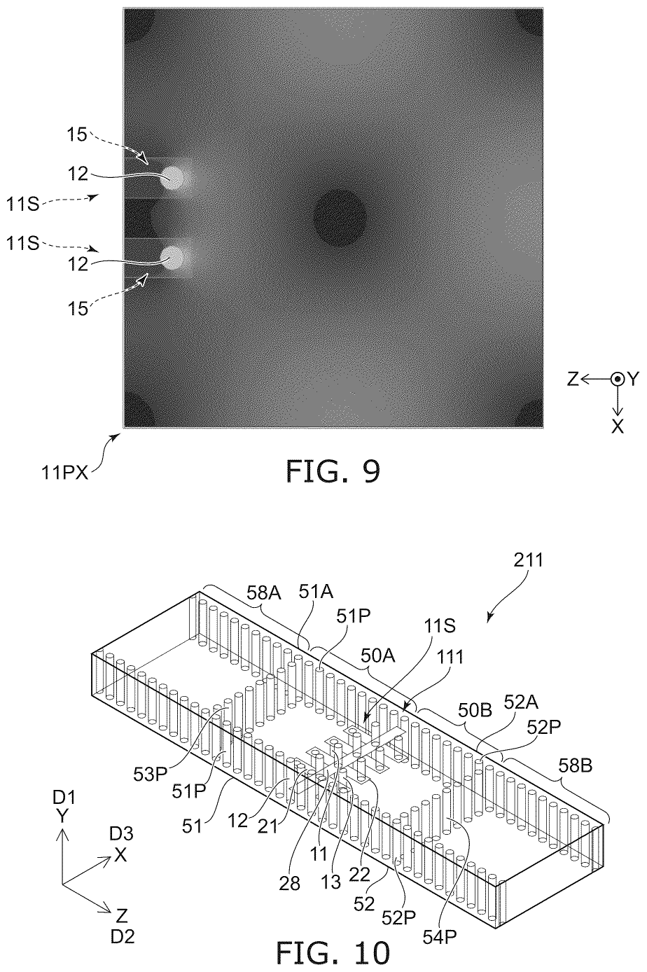

FIGS. 6 to 9 are schematic diagrams illustrating the results of the simulation.

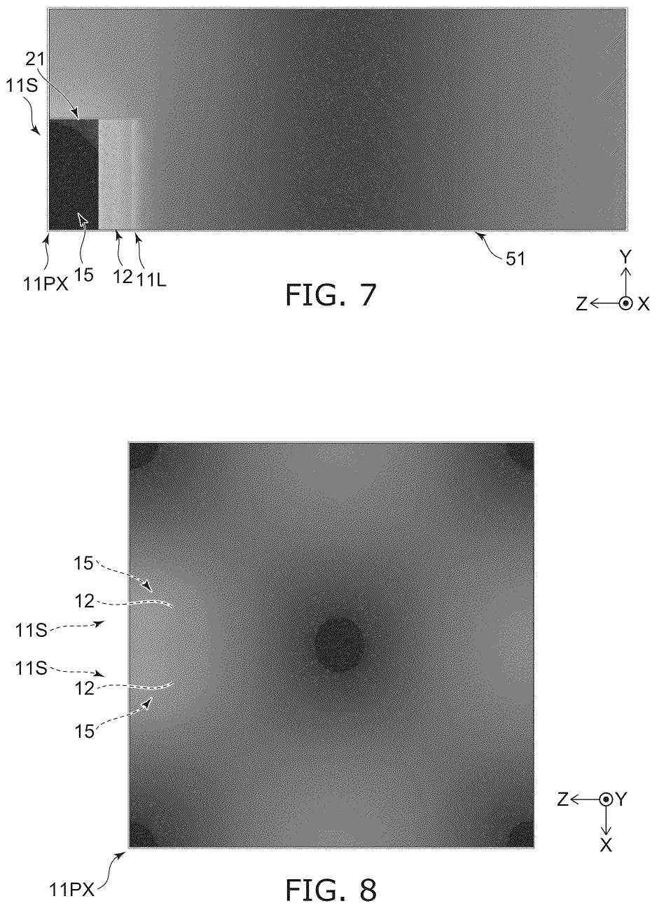

These diagrams show magnetic field strength. In these diagrams, the magnetic field strength in the bright image area is higher than the magnetic field strength in the dark image area. FIG. 6 corresponds to the characteristics of the Z-Y plane between the two first structures 11S. FIG. 7 corresponds to the characteristics of the Z-Y plane including one of the two first structures 11S. FIG. 6 corresponds to the characteristics of the Z-X plane (upper position in FIG. 5) not including the two first structures 11S. FIG. 7 corresponds to the characteristics of the Z-X plane including the two first structures 11S.

As shown in FIGS. 6 to 9, the magnetic field strength is low inside the first conductive loop 15a. This is considered to be due to the magnetic field generated by the current flowing through the plurality of conductive members included in the first conductive loop 15a acting to cancel out the magnetic field present in the first resonating portion 50A.

For example, in the example of FIG. 4, a direction of the current flowing in the portion between the first portion 11a and the first other portion 11b of the first conductive pillar 11 is opposite to a direction of the current flowing in the second conductive pillar 12. A direction of the current flowing in the first strip line 21 is opposite to a direction of the current flowing in the first partial conductive layer 11L. The magnetic field based on these currents acts to cancel out the magnetic field generated in the resonating portion. It is considered that this suppresses coupling.

FIG. 10 is a schematic transparent perspective view illustrating a connection structure according to the first embodiment.

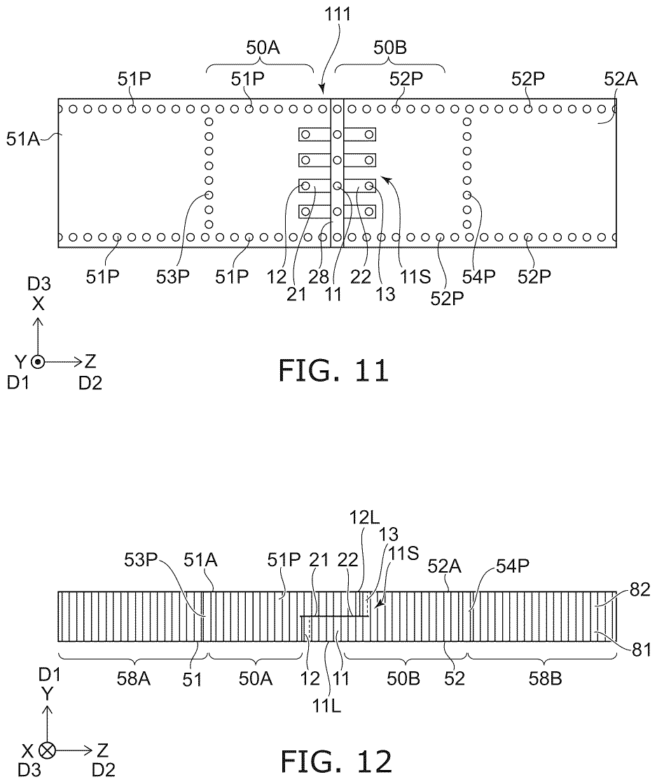

FIG. 11 is a schematic transparent plan view illustrating the connection structure according to the first embodiment.

FIG. 12 is a schematic transparent side view illustrating the connection structure according to the first embodiment.

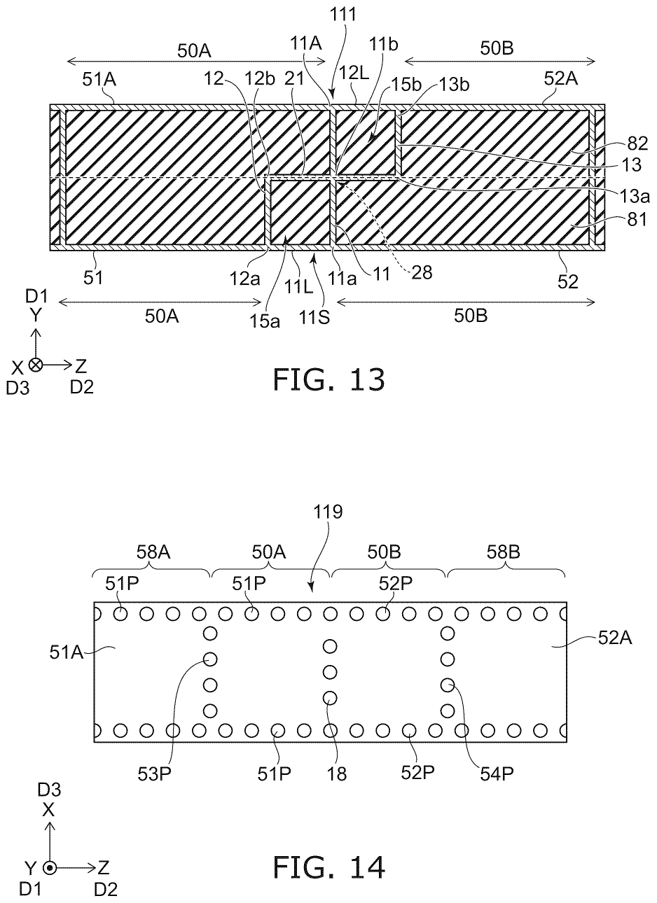

FIG. 13 is a schematic cross-sectional view illustrating the connection structure according to the first embodiment.

As shown in FIGS. 10 to 13, in a connection structure 111 according to the embodiment, the first structure 11S includes a third conductive pillar 13. The configuration of the connection structure 111 except for this may be the same as the configuration of the connection structure 110.

The third conductive pillar 13 is along the first direction D1. As shown in FIGS. 12 and 13, in this example, the first structure 11S includes a second partial conductive layer 12L.

As shown in FIG. 13, the third conductive pillar 13 includes a third portion 13a and a third other portion 13b. A direction from the third portion 13a to the third other portion 13b is along the first direction D1. A direction from the first conductive pillar 11 to the third conductive pillar 13 is along the second direction D2. For example, a position of the first conductive pillar 11 in the second direction D2 (first position) is between a position of the second conductive pillar 12 in the second direction D2 (second position) and a position of the third conductive pillar 13 in the second direction D2 (third position).

The first strip line 21 is further electrically connected to the third portion 13a in addition to the second other portion 12b and the second other portion 12b.

The second partial conductive layer 12L is electrically connected to the first opposing portion 11A and the third other portion 13b. The second partial conductive layer 12L is configured to be electrically connected to the first opposing conductive layer 51A. The second partial conductive layer 12L is configured to be electrically connected to the second opposing conductive layer 52A. The second partial conductive layer 12L may be continuous with the first opposing conductive layer 51A. The boundary between the second partial conductive layer 12L and the first opposing conductive layer 51A may be unclear. The second partial conductive layer 12L may be continuous with the second opposing conductive layer 52A. The boundary between the second partial conductive layer 12L and the second opposing conductive layer 52A may be unclear. The first opposing conductive layer 51A, the second partial conductive layer 12L, and the second opposing conductive layer 52A may be one continuous conductive layer.

In the connection structure 111, a second conductive loop 15b is formed by a part of the first conductive pillar 11, a part of the first strip line 21, the third conductive pillar 13, and the second partial conductive layer 12L. In the second conductive loop 15b, for example, the magnetic field in the connection structure 111 is cancelled. This makes it possible to connect the first resonating portion 50A and the second resonating portion 50B while further suppressing the coupling between the first resonating portion 50A and the second resonating portion 50B.

In the connection structure 111, a plurality of first structures 11S including the first conductive pillar 11, the second conductive pillar 12, and the third conductive pillar 13 may be provided. The plurality of first structures 11S are arranged along the third direction D3.

In the connection structure according to the embodiment (connection structure 110 or connection structure 111), for example, a coupling coefficient of 2×10⁻³ or less can be obtained. According to the embodiment, for example, a coupling coefficient of 1×10⁻³ or less can be obtained.

FIG. 14 is a schematic transparent plan view illustrating a connection structure of a reference example.

As shown in FIG. 14, the connection structure 119 of a reference example includes a plurality of conductive pillars 18, and does not include the first structure 11S described in relation to the embodiment. The plurality of conductive pillars 18 are arranged along the third direction D3. In the connection structure 119, the first conductive loop 15a is not provided, and the second conductive loop 15b is not provided. In the connection structure 119, the first conductive layer 51 and the first opposing conductive layer 51A are electrically connected by the plurality of conductive pillars 18. The second conductive layer 52 and the second opposing conductive layer 52A are electrically connected by the plurality of conductive pillars 18.

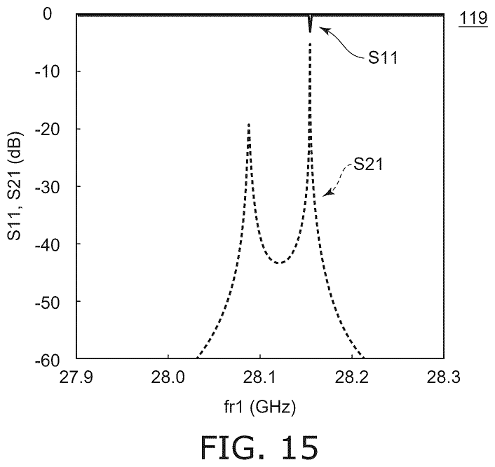

FIG. 15 is a graph illustrating the characteristics of the connection structure of the reference example.

FIG. 15 illustrates the results of a simulation of the characteristics of the connection structure 119. In this simulation, the distance dy1 (see FIG. 3) between the first conductive layer 51 and the first opposing conductive layer 51A is 2 mm. The diameter of one of the plurality of conductive pillars 18 is 0.6 mm. The distance between the plurality of conductive pillars 18 is 0.6 mm. FIG. 15 shows a transmission coefficient S21 relating to the transmission characteristic and a reflection coefficient S11 relating to the reflection characteristic. The horizontal axis of FIG. 15 is the frequency fr1.

As shown in FIG. 15, in this example, the transmission coefficient S21 has a peak when the frequency fr1 is 28.088 GHz and 28.154 GHz. At this frequency fr1, the reflection coefficient S11 drops locally. From the characteristics shown in FIG. 15, the coupling coefficient is calculated to be 2.34×10⁻³. According to the embodiment, a coupling coefficient lower than that of the reference example is obtained.

Below, an example of a simulation result of the characteristics in the embodiment will be described.

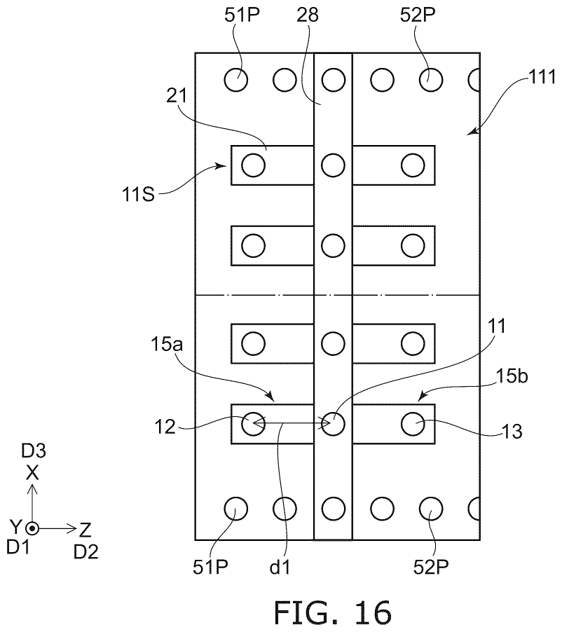

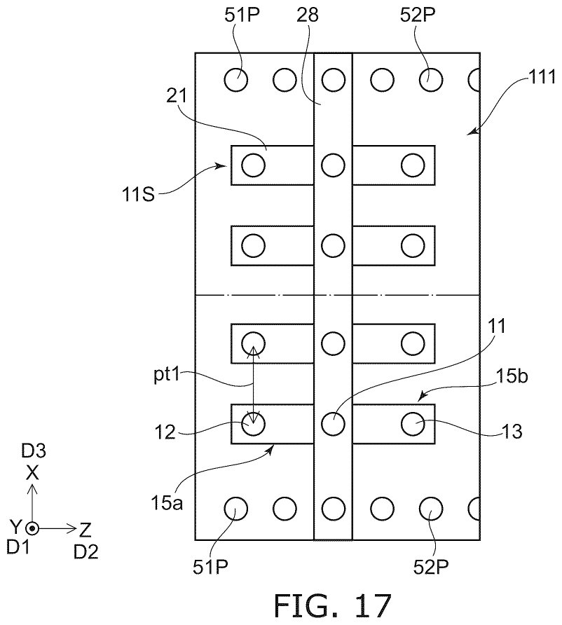

FIGS. 16 and 17 are schematic transparent plan views illustrating the connection structure.

As shown in FIG. 16, the structure of the connection structure 111 is linearly symmetrical with respect to an axis (dashed line in FIG. 16 and FIG. 17) that passes through the midpoint between the first conductive pillar 11 and the second conductive pillar 12 and is along the second direction D2.

As shown in FIG. 16, in the embodiment, a distance in the second direction D2 between a center (first center) of the first conductive pillar 11 in the second direction D2 and a center (second center) of the second conductive pillar 12 in the second direction D2 is defined as the first distance d1. As shown in FIG. 17, the pitch of the plurality of first structures 11S in the third direction D3 is defined as the pitch pt1. The pitch pt1 corresponds to the pitch of the plurality of first conductive pillars 11 in the third direction D3.

Below, an example of a simulation result of the characteristics when the first distance d1 or the pitch pt1 is changed will be described. In the simulation model, the distance dy1 (see FIG. 3) between the first conductive layer 51 and the first opposing conductive layer 51A is 2 mm. The diameters of the first conductive pillar 11, the second conductive pillar 12, and the third conductive pillar 13 are each 0.3 mm.

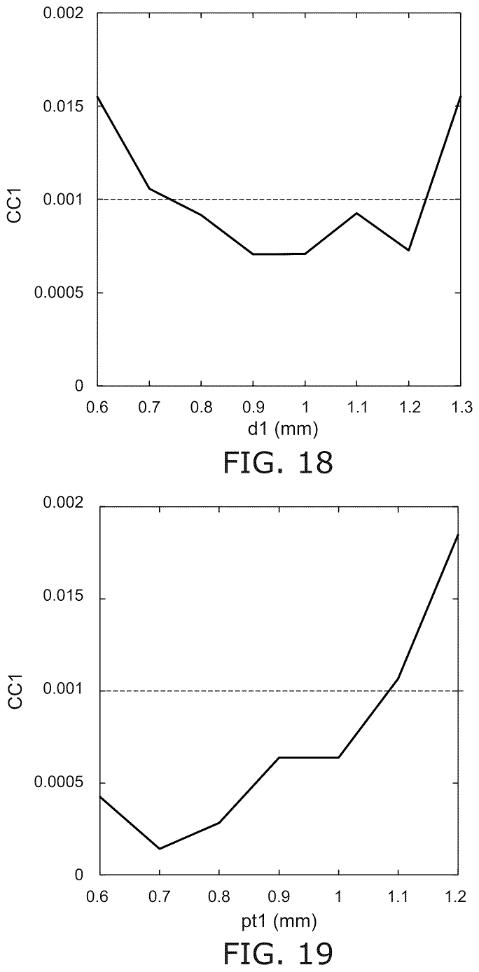

FIG. 18 is a graph illustrating the characteristics of the connection structure according to the first embodiment.

The horizontal axis of FIG. 18 is the first distance d1. The vertical axis is the coupling coefficient CC1. In FIG. 18, the pitch pt1 is 1 mm. As shown in FIG. 18, a low coupling coefficient CC1 is obtained when the first distance d1 is about not less than 0.72 mm and not more than 1.23 mm. For example, in this range, the coupling coefficient CC1 is 1×10⁻³ or less.

FIG. 19 is a graph illustrating the characteristics of the connection structure according to the first embodiment.

The horizontal axis of FIG. 19 is the pitch pt1. The vertical axis is the coupling coefficient CC1. In FIG. 19, the first distance d1 is 1 mm. As shown in FIG. 19, when the pitch pt1 is about 1.09 mm or less, a low coupling coefficient CC1 is obtained. For example, in this range, the coupling coefficient CC1 is 1×10⁻³ or less.

In the simulations of FIG. 18 and FIG. 19, the wavelength λ of the signal propagating through the first resonating portion 50A is 10 mm. The wavelength λ corresponds to the guided wavelength. From the results of FIG. 18, it is preferable that the first distance d1 is not less than 0.07 times and not more than 0.12 times the wavelength λ. From the results of FIG. 19, it is preferable that the pitch pt1 is 0.11 times or less the wavelength λ. A low coupling coefficient CC1 is effectively obtained.

Some examples of the connection structure according to the first embodiment are described below.

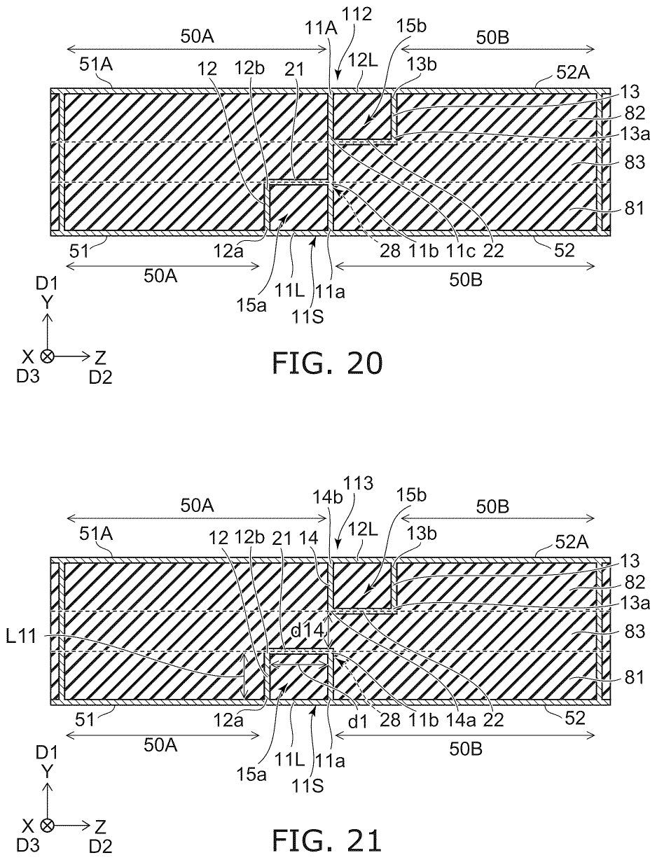

FIG. 20 is a schematic cross-sectional view illustrating the connection structure according to the first embodiment.

As shown in FIG. 20, in a connection structure 112 according to the embodiment, the first conductive pillar 11 includes a first intermediate portion 11c and the first opposing portion 11A in addition to the first portion 11a and the first other portion 11b. The configuration of the connection structure 112 except for this may be similar to the configuration of the connection structure 111.

The first other portion 11b is between the first portion 11a and the first opposing portion 11A in the first direction D1. The first intermediate portion 11c is between the first other portion 11b and the first opposing portion 11A in the first direction D1.

The first structure 11S includes the third conductive pillar 13 along the first direction D1, a second strip line 22, and the second partial conductive layer 12L. The third conductive pillar 13 includes the third portion 13a and the third other portion 13b. The direction from the third portion 13a to the third other portion 13b is along the first direction D1. The direction from the first conductive pillar 11 to the third conductive pillar 13 is along the second direction D2.

For example, the position of the first conductive pillar 11 in the second direction D2 (first position) is between the position of the second conductive pillar 12 in the second direction D2 (second position) and the position of the third conductive pillar 13 in the second direction D2 (third position).

The second strip line 22 is electrically connected to the first intermediate portion 11c and the third portion 13a, and extends along the second direction D2.

The second partial conductive layer 12L is electrically connected to the first opposing portion 11A and the third other portion 13b. The second partial conductive layer 12L is configured to be electrically connected to the first opposing conductive layer 51A. The second partial conductive layer 12L is electrically connected to the second opposing conductive layer 52A.

The second partial conductive layer 12L may be continuous with the first opposing conductive layer 51A. The second partial conductive layer 12L may be continuous with the second opposing conductive layer 52A. The boundary between the second partial conductive layer 12L and the first opposing conductive layer 51A may be unclear. The boundary between the second partial conductive layer 12L and the second opposing conductive layer 52A may be unclear.

In the connection structure 112, the first conductive loop 15a and the second conductive loop 15b are provided. The magnetic field is cancelled. The first resonating portion 50A and the second resonating portion 50B can be connected while suppressing the coupling between the first resonating portion 50A and the second resonating portion 50B.

In the connection structure 112, in addition to the first base 81 and the second base 82, a third base 83 may be provided.

FIG. 21 is a schematic cross-sectional view illustrating a connection structure according to the first embodiment.

As shown in FIG. 21, in a connection structure 113 according to the embodiment, the third conductive pillar 13 and a fourth conductive pillar 14 are provided. The configuration of the connection structure 113 except for this may be similar to that of the connection structure 112.

In the connection structure 113, the first structure 11S includes a third conductive pillar 13, a fourth conductive pillar 14, a second strip line 22, and a second partial conductive layer 12L. The third conductive pillar 13 and the fourth conductive pillar 14 are along the first direction D1.

The third conductive pillar 13 includes the third portion 13a and the third other portion 13b. The direction from the third portion 13a to the third other portion 13b is along the first direction D1. The fourth conductive pillar 14 includes a fourth portion 14a and a fourth other portion 14b. A direction from the fourth portion 14a to the fourth other portion 14b is along the first direction D1. A direction from the fourth conductive pillar 14 to the third conductive pillar 13 is along the second direction D2.

The second strip line 22 is electrically connected to the third portion 13a and the fourth portion 14a. The second partial conductive layer 12L is electrically connected to the third other portion 13b and the fourth other portion 14b.

The second partial conductive layer 12L is configured to be electrically connected to the first opposing conductive layer 51A. The second partial conductive layer 12L is electrically connected to the second opposing conductive layer 52A.

The second partial conductive layer 12L may be continuous with the first opposing conductive layer 51A. The second partial conductive layer 12L may be continuous with the second opposing conductive layer 52A. The boundary between the second partial conductive layer 12L and the first opposing conductive layer 51A may be unclear. The boundary between the second partial conductive layer 12L and the second opposing conductive layer 52A may be unclear.

In the connection structure 113, the first conductive loop 15a and the second conductive loop 15b are provided. The magnetic field is cancelled. The first resonating portion 50A and the second resonating portion 50B can be connected while suppressing the coupling between the first resonating portion 50A and the second resonating portion 50B.

In the connection structure 113, the position (first position) of the first conductive pillar 11 in the second direction D2 is between the position (second position) of the second conductive pillar 12 in the second direction D2 and the position (third position) of the third conductive pillar 13 in the second direction D2. A fourth position of the fourth conductive pillar 14 in the second direction D2 is between the second position and the third position.

A distance d14 between the first conductive pillar 11 and the fourth conductive pillar 14 may be, for example, 1/10 times or less the length L11 of the first conductive pillar 11 along the first direction D1. The distance d14 may be, for example, 1/10 times or less the first distance d1. As already explained, the first distance d1 is the distance in the second direction D2 between the center (first center) of the first conductive pillar 11 in the second direction D2 and the center (second center) of the second conductive pillar 12 in the second direction D2. The distance d14 may be, for example, ¼ times or less the wavelength λ of the signal propagating through the first resonating portion 50A. The distance d14 may be, for example, 1/10 times or less the wavelength λ.

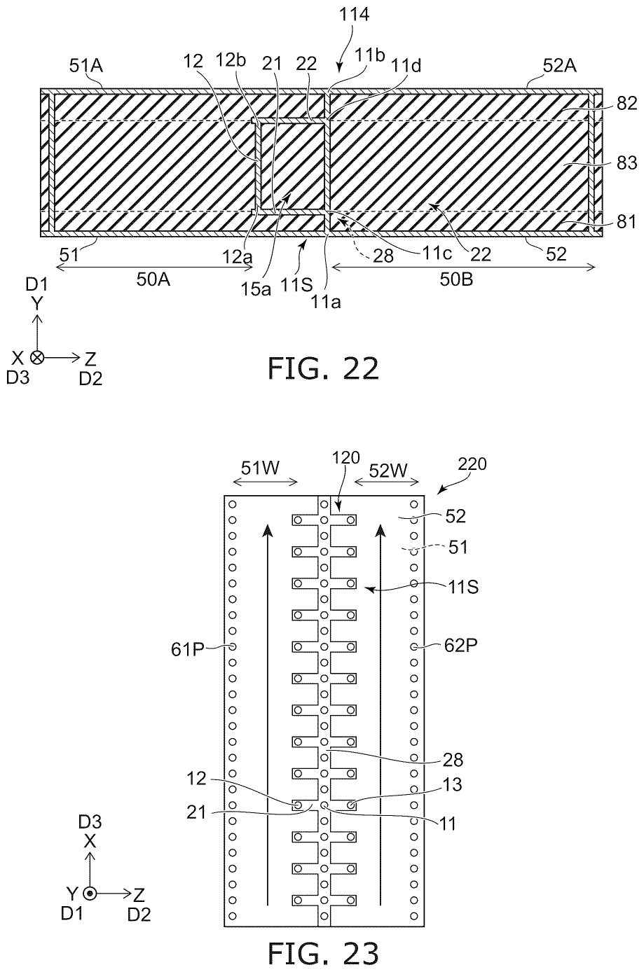

FIG. 22 is a schematic cross-sectional view illustrating a connection structure according to the first embodiment.

As shown in FIG. 22, in a connection structure 114 according to the embodiment, the first conductive pillar 11 includes the first intermediate portion 11c and a second intermediate portion 11d. The configuration of the connection structure 114 except for this may be similar to the configuration of the connection structure 111, etc.

In the connection structure 114, the connection structure 114 is provided between the first resonating portion 50A and the second resonating portion 50B. The connection structure 114 includes the first structure 11S. The first structure 11S includes the first conductive pillar 11, the second conductive pillar 12, the first strip line 21, and a second strip line 22.

The first conductive pillar 11 includes the first portion 11a, the first other portion 11b, the first intermediate portion 11c, and the second intermediate portion 11d. The first conductive pillar 11 is along the first direction D1. The direction from the first portion 11a to the first other portion 11b is along the first direction D1. The first intermediate portion 11c is between the first portion 11a and the first other portion 11b in the first direction D1. The second intermediate portion 11d is between the first intermediate portion 11c and the first other portion 11b in the first direction D1.

The second conductive pillar 12 includes a second portion 12a and a second other portion 12b. The second conductive pillar 12 is along the first direction D1. The direction from the second portion 12a to the second other portion 12b is along the first direction D1. The second direction D2 from the second conductive pillar 12 to the first conductive pillar 11 crosses the first direction D1. The direction from the first resonating portion 50A to the second resonating portion 50B is along the second direction D2.

The first strip line 21 is electrically connected to the second portion 12a and the first intermediate portion 11c, and extends along the second direction D2. The second strip line 22 is electrically connected to the second other portion 12b and the second intermediate portion 11d, and extends along the second direction D2.

In the connection structure 114, the first conductive loop 15a is formed by the first conductive pillar 11, the second conductive pillar 12, the first strip line 21, and the second strip line 22. The magnetic field is cancelled. The first resonating portion 50A and the second resonating portion 50B can be connected while suppressing coupling between the first resonating portion 50A and the second resonating portion 50B.

For example, the first conductive pillar 11 is configured to be electrically connected to the first conductive layer 51 included in the first resonating portion 50A. For example, the first conductive pillar 11 is configured to be electrically connected to the second conductive layer 52 included in the second resonating portion 50B. The first conductive pillar 11 is electrically connected to the first opposing conductive layer 51A. The first conductive pillar 11 is electrically connected to the second opposing conductive layer 52A.

### Second Embodiment

FIG. 23 is a schematic transparent plan view illustrating a connection structure according to a second embodiment.

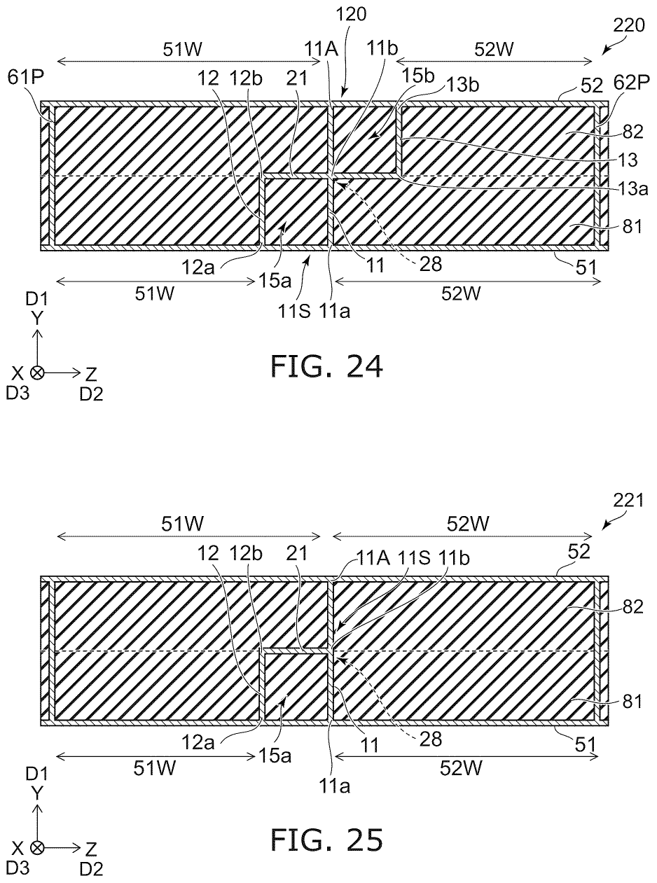

FIG. 24 is a schematic cross-sectional view illustrating a connection structure according to the second embodiment.

As shown in FIGS. 23 and 24, a waveguide 220 according to the embodiment includes a first conductive layer 51, a second conductive layer 52, a plurality of first waveguide portion conductive pillars 61P, a plurality of second waveguide portion conductive pillars 62P, and a plurality of first structures 11S.

A direction from the first conductive layer 51 to the second conductive layer 52 is along the first direction D1. The plurality of first waveguide portion conductive pillars 61P are electrically connected to the first conductive layer 51 and the second conductive layer 52. The plurality of second waveguide portion conductive pillars 62P are electrically connected to the first conductive layer 51 and the second conductive layer 52. The plurality of first waveguide portion conductive pillars 61P and the plurality of second waveguide portion conductive pillars 62P are along the first direction D1.

A direction from the plurality of first waveguide portion conductive pillars 61P to the plurality of second waveguide portion conductive pillars 62P is along the second direction D2 crossing the first direction D1. The plurality of first waveguide portion conductive pillars 61P are arranged along the third direction D3. The third direction D3 crosses a plane including the first direction D1 and the second direction D2. The plurality of second waveguide portion conductive pillars 62P are arranged along the third direction D3. The plurality of first structures 11S are arranged along the third direction D3.

One of the plurality of first structures 11S includes a first conductive pillar 11, a second conductive pillar 12, and a first strip line 21.

The first conductive pillar 11 includes a first portion 11a and a first other portion 11b. The first conductive pillar 11 is along the first direction D1. The direction from the first portion 11a to the first other portion 11b is along the first direction D1.

The second conductive pillar 12 includes a second portion 12a and a second other portion 12b. The second conductive pillar 12 is arranged along the first direction D1. The direction from the second portion 12a to the second other portion 12b is along the first direction D1. The direction from the second conductive pillar 12 to the first conductive pillar 11 is along the second direction D2.

The first strip line 21 is electrically connected to the first other portion 11b and the second other portion 12b. The first strip line 21 is along the second direction D2. The first conductive pillar 11 is electrically connected to at least one of the first conductive layer 51 or the second conductive layer 52.

In the waveguide 220, a region between the plurality of first waveguide portion conductive pillars 61P and the plurality of first structures 11S functions as the first waveguide portion 51W. A region between the plurality of second waveguide portion conductive pillars 62P and the plurality of first structures 11S functions as the second waveguide portion 52W. A signal (e.g., an electromagnetic wave) propagates through these waveguide portions along the third direction D3. A separation structure 120 including the plurality of first structures 11S has the function of separating these waveguides.

In the waveguide 220, the second conductive pillar 12, a part of the first conductive pillar 11, the first strip line 21, and a part of the first conductive layer 51 form a first conductive loop 15a. Coupling in the plurality of waveguides is suppressed. According to the embodiment, a waveguide with improved characteristics can be provided.

In the waveguide 220, the second conductive pillar 12 may be electrically connected to at least one of the first conductive layer 51 or the second conductive layer 52.

In this example, one of the plurality of first structures 11S includes a third conductive pillar 13. The third conductive pillar 13 includes a third portion 13a and a third other portion 13b. The direction from the third portion 13a to the third other portion 13b is along the first direction D1. The first conductive pillar 11 includes a first opposing portion 11A. The first strip line 21 is further electrically connected to the third portion 13a. The third other portion 13b is electrically connected to the second conductive layer 52.

The second conductive loop 15b is formed by the third conductive pillar 13, a part of the first conductive pillar 11, the first strip line 21, and a part of the second conductive layer 52. Coupling in the plurality of waveguides is further suppressed. According to the embodiment, a waveguide that can improve characteristics can be provided.

FIGS. 25 to 28 are schematic cross-sectional views illustrating connection structures according to the second embodiment.

As shown in FIG. 25, a waveguide 221 may include the configuration described for the connection structure 110. The configuration of the waveguide 221 except for this may be similar to the configuration of the waveguide 220.

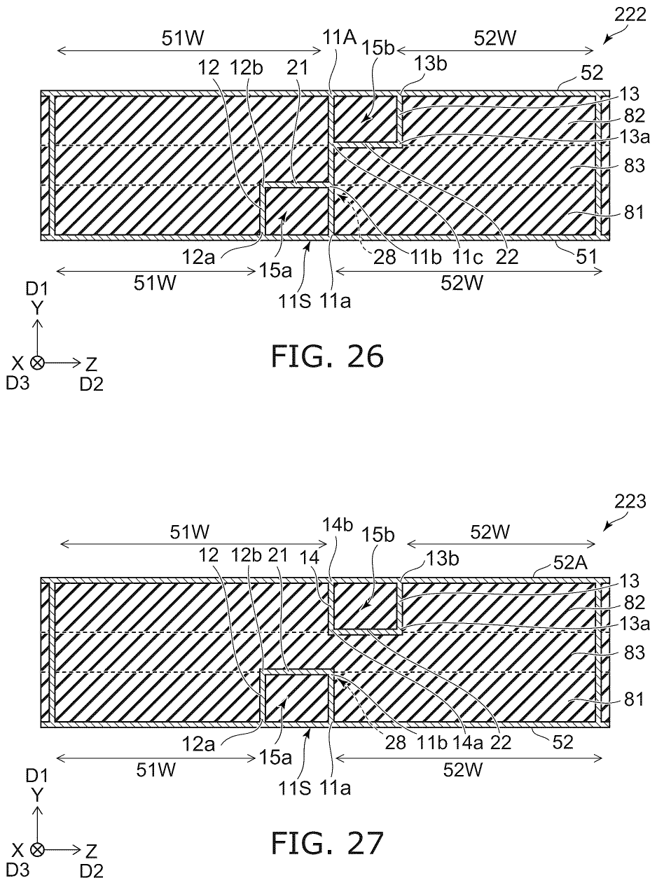

As shown in FIG. 26, the waveguide 222 may include the configuration described for the connection structure 112. The configuration of the waveguide 222 except for this may be similar to the configuration of the waveguide 220.

As shown in FIG. 27, the waveguide 223 may include the configuration described with respect to the connection structure 113. The configuration of the waveguide 223 except for this may be similar to that of the waveguide 220.

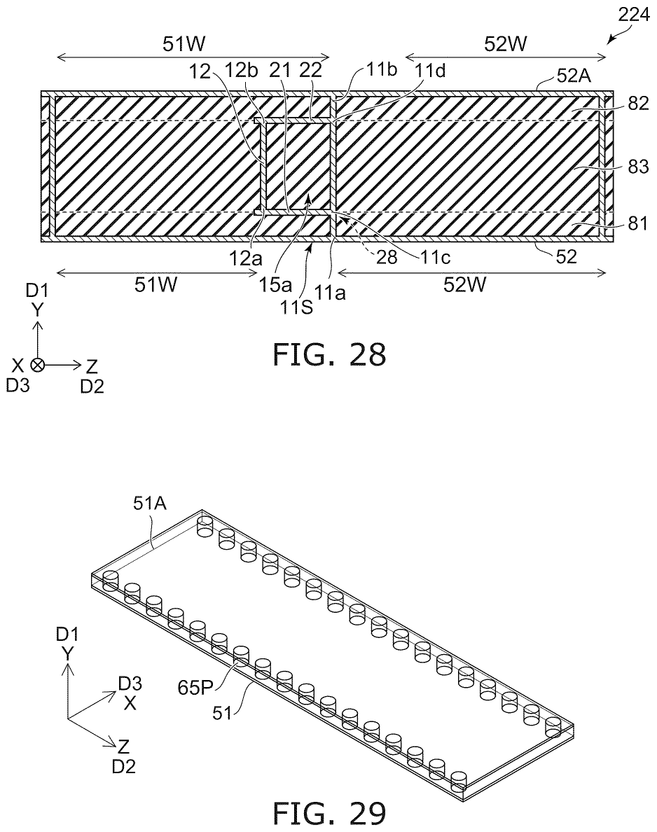

As shown in FIG. 28, a waveguide 224 may include the configuration described with respect to the connection structure 114. The configuration of the waveguide 224 except for this may be similar to the configuration of the waveguide 220.

In the embodiment, at least one of the first conductive pillar 11, the second conductive pillar 12, the third conductive pillar 13, or the fourth conductive pillar 14 may include a metal. The metal may include, for example, at least one selected from the group consisting of copper, silver, aluminum, and gold.

At least one of the first resonating portion conductive pillar 51P, the second resonating portion conductive pillar 52P, the third resonating portion conductive pillar 53P, the fourth resonating portion conductive pillar 54P, the first waveguide portion conductive pillar 61P, and the second waveguide portion conductive pillar 62P may include the above metal.

The conductive pillar may be formed, for example, by filling a hole provided in a base with a conductive member. For example, the conductive pillar may be obtained by a method such as plating.

At least one of the first conductive layer 51, the first opposing conductive layer 51A, the second conductive layer 52, and the second opposing conductive layer 52A may include the above metal.

The first base 81, the second base 82, and the third base 83 may include a dielectric. At least one of these bases may include at least one selected from the group consisting of an oxide, a glass cloth, and a resin. The oxide may include, for example, aluminum oxide. The resin may include, for example, PTFE. At least one of the thickness and the dielectric constant may be different from each other in the first base 81, the second base 82, and the third base 83.

FIGS. 29 to 31 are schematic views illustrating a waveguide of a reference example.

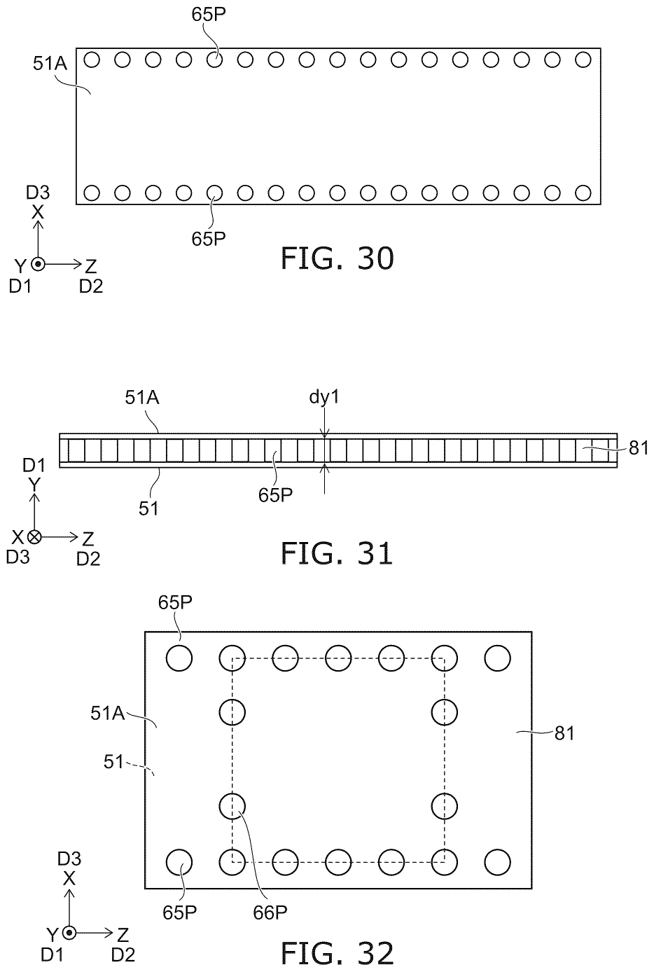

FIG. 29 is a transparent perspective view. FIG. 30 is a transparent plan view. FIG. 31 is a transparent side view.

These figures illustrate an SIW. In the SIW resonator, a first conductive layer 51, a first opposing conductive layer 51A, and a plurality of conductive pillars 65P are provided. The plurality of conductive pillars 65P are arranged along the second direction D2.

FIG. 32 is a schematic diagram illustrating a resonator of a reference example.

As shown in FIG. 32, in the SIW structure, a row including a plurality of conductive pillars 66P arranged along the third direction D3 is provided. By shortening the distance in the second direction D2 of the plurality of rows, the SIW structure functions as a resonator.

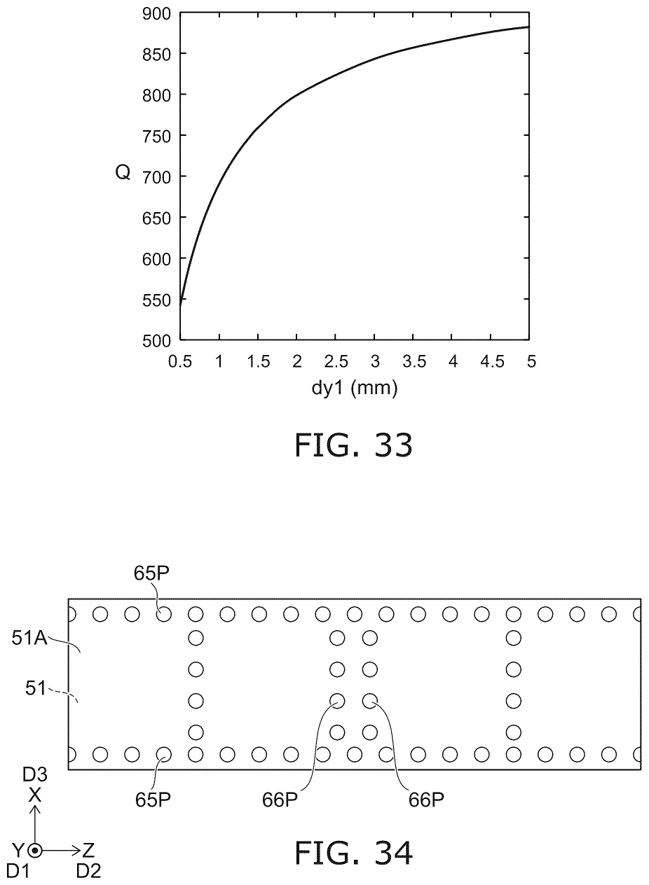

FIG. 33 is a schematic diagram illustrating the characteristics of a resonator of a reference example.

As shown in FIG. 33, the characteristics are illustrated when the distance between the first conductive layer 51 and the first opposing conductive layer 51A is changed in the resonator illustrated in FIG. 32. The horizontal axis is the distance dy1 (see FIG. 31) between the first conductive layer 51 and the first opposing conductive layer 51A along the first direction D1. The vertical axis is the unloaded Q factor.

As shown in FIG. 33, as the distance dy1 increases, the unloaded Q factor increases. For example, by increasing the distance dy1, the loss in the SIW resonator can be reduced. However, in an SIW structure with a long distance dy1, the conductive pillar 65P becomes long, making manufacturing difficult. In order to easily form the conductive pillar 65P in a configuration with a long distance dy1, a method can be considered in which the diameter of the conductive pillar 65P and the pitch of the plurality of conductive pillars 65P are increased. However, in this case, unwanted coupling between the plurality of resonators or unwanted radiation is more likely to occur.

FIG. 34 is a schematic transparent plan view illustrating a waveguide of a reference example.

As shown in FIG. 34, a plurality of rows including a plurality of conductive pillars 66P aligned along the third direction D3 are provided. It is considered that the above-mentioned unnecessary coupling or unnecessary radiation can be reduced by increasing the number of rows. However, increasing the number of rows of the plurality of conductive pillars 66P increases the size of the circuit.

In the embodiment, by applying the above-mentioned first structure 11S, unnecessary coupling and radiation can be suppressed while keeping the circuit small. In the above example, the conductive loop (such as the first conductive loop 15a) is along a plane including the first direction D1 and the second direction D2. In the embodiment, for example, the conductive loop may be along a plane that is inclined with respect to the plane including the first direction D1 and the second direction D2. The angle of inclination may be, for example, 45 degrees or less.

The embodiment may include the following Technical proposals:

### Technical Proposal 1

A connection structure configured to be provided between a first resonating portion and a second resonating portion,

the connection structure comprising a first structure,

the first structure including:
a first conductive pillar including a first portion and a first other portion, the first conductive pillar being along a first direction, a direction from the first portion to the first other portion being along the first direction;
a second conductive pillar including a second portion and a second other portion, the second conductive pillar being along the first direction, a direction from the second portion to the second other portion being along the first direction, a second direction from the second conductive pillar to the first conductive pillar crossing the first direction, and a direction from the first resonating portion to the second resonating portion being along the second direction;
a first strip line electrically connected to the first other portion and the second other portion, the first strip line being along the second direction; and
a first partial conductive layer electrically connected to the first portion and the second portion.

### Technical Proposal 2

The connection structure according to Technical proposal 1, wherein

the first partial conductive layer is electrically connected to a first conductive layer included in the first resonating portion.

### Technical Proposal 3

The connection structure according to Technical proposal 1, wherein

the first resonating portion includes a first conductive layer, a first opposing conductive layer, and a plurality of first resonating portion conductive pillars,

a direction from the first conductive layer to the first opposing conductive layer is along the first direction,

the plurality of first resonating portion conductive pillars electrically connect the first opposing conductive layer to the first conductive layer,

the second resonating portion includes a second conductive layer, a second opposing conductive layer, and a plurality of second resonating portion conductive pillars,

a direction from the second conductive layer to the second opposing conductive layer is along the first direction,

the plurality of second resonating portion conductive pillars electrically connect the second opposing conductive layer to the second conductive layer, and

the first partial conductive layer is configured to be continuous with the first conductive layer.

### Technical Proposal 4

The Connection Structure According to Technical Proposal 3, wherein

the first conductive pillar includes a first opposing portion,

the first other portion is between the first portion and the first opposing portion in the first direction, and

the first opposing portion is configured to be electrically connected to the first opposing conductive layer.

### Technical Proposal 5

The connection structure according to Technical proposal 4, wherein

the first structure further includes:
a third conductive pillar along the first direction; and
a second partial conductive layer,

the third conductive pillar includes a third portion and a third other portion,

a direction from the third portion to the third other portion is along the first direction,

a direction from the first conductive pillar to the third conductive pillar is along the second direction,

the first strip line is further electrically connected to the third portion,

the second partial conductive layer is electrically connected to the first opposing portion and the third other portion, and

the second partial conductive layer is configured to be electrically connected to the first opposing conductive layer.

### Technical Proposal 6

The connection structure according to Technical proposal 3, wherein

the first conductive pillar includes a first intermediate portion and a first opposing portion,

the first other portion is between the first portion and the first opposing portion in the first direction,

the first intermediate portion is between the first other portion and the first opposing portion in the first direction,

the first structure further includes
a third conductive pillar along the first direction,
a second strip line, and
a second partial conductive layer,

the third conductive pillar includes a third portion and a third other portion,

a direction from the third portion to the third other portion is along the first direction,

a direction from the first conductive pillar to the third conductive pillar is along the second direction,

the second strip line is electrically connected to the first intermediate portion and the third portion and extends along the second direction,

the second partial conductive layer is electrically connected to the first opposing portion and the third other portion, and

the second partial conductive layer is configured to be electrically connected to the first opposing conductive layer.

### Technical Proposal 7

The connection structure according to Technical proposal 3, wherein

the first structure further includes:
a third conductive pillar along the first direction,
a fourth conductive pillar along the first direction,
a second strip line, and
a second partial conductive layer,

the third conductive pillar includes a third portion and a third other portion,

a direction from the third portion to the third other portion is along the first direction,

the fourth conductive pillar includes a fourth portion and a fourth other portion,

a direction from the fourth portion to the fourth other portion is along the first direction,

a direction from the fourth conductive pillar to the third conductive pillar is along the second direction,

the second strip line is electrically connected to the third portion and the fourth portion,

the second partial conductive layer is electrically connected to the third other portion and the fourth other portion, and

the second partial conductive layer is configured to be electrically connected to the first opposing conductive layer.

### Technical Proposal 8

The connection structure according to Technical Proposal 7, wherein

a first position of the first conductive pillar in the second direction is between a second position of the second conductive pillar in the second direction and a third position of the third conductive pillar in the second direction,

a fourth position of the fourth conductive pillar in the second direction is between the second position and the third position, and

a distance between the first conductive pillar and the fourth conductive pillar is 1/10 or less of a length of the first conductive pillar along the first direction.

### Technical Proposal 9

A connection structure configured to be provided between a first resonating portion and a second resonating portion,

the connection structure comprising a first structure,

the first structure including:
a first conductive pillar including a first portion, a first other portion, a first intermediate portion, and a second intermediate portion, the first conductive pillar being along a first direction, a direction from the first portion to the first other portion being along the first direction, the first intermediate portion being between the first portion and the first other portion in the first direction, the second intermediate portion being between the first intermediate portion and the first other portion in the first direction;
a second conductive pillar including a second portion and a second other portion, the second conductive pillar being along the first direction, a direction from the second portion to the second other portion being along the first direction, a second direction from the second conductive pillar to the first conductive pillar crossing the first direction, a direction from the first resonating portion to the second resonating portion being along the second direction;
a first strip line electrically connected to the second portion and the first intermediate portion, the first strip line being along the second direction; and
a second strip line electrically connected to the second other portion and the second intermediate portion, the second strip line being along the second direction.

### Technical Proposal 10

The connection structure according to technical proposal 9, wherein

the first conductive pillar is configured to be electrically connected to a first conductive layer included in the first resonating portion.

### Technical Proposal 11

The connection structure according to any one of Technical proposals 1-10, wherein

a plurality of the first structures are provided, and

a third direction from one of the plurality of the first structures to another one of the plurality of the first structures crosses a plane including the first direction and the second direction.

### Technical Proposal 12

The connection structure according to Technical proposal 11, further comprising:

a first connection conductive layer,

the first connection conductive layer is along the third direction, and

the first connection conductive layer electrically connects the plurality of first structures.

### Technical Proposal 13

The connection structure according to Technical proposal 11 or 12, wherein

a pitch of the plurality of first structures in the third direction is 0.11 times or less a wavelength of a signal to propagate through the first resonating portion.

### Technical Proposal 14

The connection structure according to any one of Technical proposals 1-13, wherein

a first distance in the second direction between a first center in the second direction of the first conductive pillar and a second center in the second direction of the second conductive pillar is not less than 0.07 times and not more than 0.12 times a wavelength of a signal to propagate through the first resonating portion.

Technical proposal 15

The connection structure according to Technical proposal 7, wherein

a first position of the first conductive pillar in the second direction is between a second position of the second conductive pillar in the second direction and a third position of the third conductive pillar in the second direction,

a fourth position of the fourth conductive pillar in the second direction is between the second position and the third position, and

a distance between the first conductive pillar and the fourth conductive pillar is ¼ or less of a wavelength of a signal to propagate through the first resonating portion.

### Technical Proposal 16

The connection structure according to Technical proposal 3, wherein

a part of the plurality of first resonating portion conductive pillars is arranged along the second direction,

another part of the plurality of first resonating portion conductive pillars is arranged along the second direction, and

a direction from the part of the plurality of first resonating portion conductive pillars to the other part of the plurality of first resonating portion conductive pillars is along a third direction crossing a plane including the first direction and the second direction.

### Technical Proposal 17

The connection structure according to Technical proposal 3, wherein

the second conductive layer is configured to be electrically connected to the first conductive layer, and

the second opposing conductive layer is configured to be electrically connected to the first opposing conductive layer.

### Technical Proposal 18

A connection structure configured to be provided between a first resonating portion and a second resonating portion,

the connection structure comprising a first structure including a first conductive loop,

the first conductive loop being along a first direction and a second direction crossing the first direction, and

a direction from the first resonating portion to the second resonating portion being aligned along the second direction.

### Technical Proposal 19

A waveguide, comprising:
a first conductive layer;

a second conductive layer, a direction from the first conductive layer to the second conductive layer being along a first direction;

a plurality of first waveguide portion conductive pillars electrically connected to the first conductive layer and the second conductive layer;

a plurality of second waveguide portion conductive pillars electrically connected to the first conductive layer and the second conductive layer; and

a plurality of first structures,

a direction from the plurality of first waveguide portion conductive pillars to the plurality of second waveguide portion conductive pillars being along a second direction crossing the first direction,

the plurality of first waveguide portion conductive pillars being arranged along a third direction crossing a plane including the first direction and the second direction,

the plurality of second waveguide portion conductive pillars being arranged along the third direction,

the plurality of first structures being aligned along the third direction,

one of the plurality of first structures including:
a first conductive pillar including a first portion and a first other portion, the first conductive pillar being along the first direction, a direction from the first portion to the first other portion being along the first direction;
a second conductive pillar including a second portion and a second other portion, the second conductive pillar being along the first direction, a direction from the second portion to the second other portion being along the first direction, a direction from the second conductive pillar to the first conductive pillar being along the second direction; and
a first strip line electrically connected to the first other portion and the second other portion, the first strip line being along the second direction,

the first conductive pillar being electrically connected to at least one of the first conductive layer or the second conductive layer.

### Technical Proposal 20

The waveguide portion according to Technical proposal 19, wherein

the second conductive pillar is electrically connected to at least one of the first conductive layer or the second conductive layer.

According to the embodiment, a connection structure and a waveguide are provided that can improve characteristics.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the connecting structures or waveguides, such as conductive layers, conductive pillars, strip lines, bases, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all connecting structures and all waveguides practicable by an appropriate design modification by one skilled in the art based on the connecting structures and the waveguides described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A connection structure configured to be provided between a first resonating portion and a second resonating portion,
the connection structure comprising a first structure,
the first structure including:
a first conductive pillar including a first portion and a first other portion, the first conductive pillar being along a first direction, a direction from the first portion to the first other portion being along the first direction;
a second conductive pillar including a second portion and a second other portion, the second conductive pillar being along the first direction, a direction from the second portion to the second other portion being along the first direction, a second direction from the second conductive pillar to the first conductive pillar crossing the first direction, and a direction from the first resonating portion to the second resonating portion being along the second direction;
a first strip line electrically connected to the first other portion and the second other portion, the first strip line being along the second direction; and
a first partial conductive layer electrically connected to the first portion and the second portion.

2. The connection structure according to claim 1, wherein
the first partial conductive layer is electrically connected to a first conductive layer included in the first resonating portion.

3. The connection structure according to claim 1, wherein
the first resonating portion includes a first conductive layer, a first opposing conductive layer, and a plurality of first resonating portion conductive pillars,
a direction from the first conductive layer to the first opposing conductive layer is along the first direction,
the plurality of first resonating portion conductive pillars electrically connect the first opposing conductive layer to the first conductive layer,
the second resonating portion includes a second conductive layer, a second opposing conductive layer, and a plurality of second resonating portion conductive pillars,
a direction from the second conductive layer to the second opposing conductive layer is along the first direction,
the plurality of second resonating portion conductive pillars electrically connect the second opposing conductive layer to the second conductive layer, and
the first partial conductive layer is configured to be continuous with the first conductive layer.

4. The connection structure according to claim 3, wherein
the first conductive pillar includes a first opposing portion,
the first other portion is between the first portion and the first opposing portion in the first direction, and
the first opposing portion is configured to be electrically connected to the first opposing conductive layer.

5. The connection structure according to claim 4, wherein
the first structure further includes:
a third conductive pillar along the first direction; and
a second partial conductive layer,
the third conductive pillar includes a third portion and a third other portion,
a direction from the third portion to the third other portion is along the first direction,
a direction from the first conductive pillar to the third conductive pillar is along the second direction,
the first strip line is further electrically connected to the third portion,
the second partial conductive layer is electrically connected to the first opposing portion and the third other portion, and
the second partial conductive layer is configured to be electrically connected to the first opposing conductive layer.

6. The connection structure according to claim 3, wherein
the first conductive pillar includes a first intermediate portion and a first opposing portion,
the first other portion is between the first portion and the first opposing portion in the first direction,
the first intermediate portion is between the first other portion and the first opposing portion in the first direction,
the first structure further includes
a third conductive pillar along the first direction,
a second strip line, and
a second partial conductive layer,
the third conductive pillar includes a third portion and a third other portion,
a direction from the third portion to the third other portion is along the first direction,
a direction from the first conductive pillar to the third conductive pillar is along the second direction,
the second strip line is electrically connected to the first intermediate portion and the third portion and extends along the second direction,
the second partial conductive layer is electrically connected to the first opposing portion and the third other portion, and
the second partial conductive layer is configured to be electrically connected to the first opposing conductive layer.

7. The connection structure according to claim 3, wherein
the first structure further includes:
a third conductive pillar along the first direction,
a fourth conductive pillar along the first direction,
a second strip line, and
a second partial conductive layer,
the third conductive pillar includes a third portion and a third other portion,
a direction from the third portion to the third other portion is along the first direction,
the fourth conductive pillar includes a fourth portion and a fourth other portion,
a direction from the fourth portion to the fourth other portion is along the first direction,
a direction from the fourth conductive pillar to the third conductive pillar is along the second direction,
the second strip line is electrically connected to the third portion and the fourth portion,
the second partial conductive layer is electrically connected to the third other portion and the fourth other portion, and
the second partial conductive layer is configured to be electrically connected to the first opposing conductive layer.

8. The connection structure according to claim 7, wherein
a first position of the first conductive pillar in the second direction is between a second position of the second conductive pillar in the second direction and a third position of the third conductive pillar in the second direction,
a fourth position of the fourth conductive pillar in the second direction is between the second position and the third position, and
a distance between the first conductive pillar and the fourth conductive pillar is 1/10 or less of a length of the first conductive pillar along the first direction.

9. A connection structure configured to be provided between a first resonating portion and a second resonating portion,
the connection structure comprising a first structure,
the first structure including:
a first conductive pillar including a first portion, a first other portion, a first intermediate portion, and a second intermediate portion, the first conductive pillar being along a first direction, a direction from the first portion to the first other portion being along the first direction, the first intermediate portion being between the first portion and the first other portion in the first direction, the second intermediate portion being between the first intermediate portion and the first other portion in the first direction;
a second conductive pillar including a second portion and a second other portion, the second conductive pillar being along the first direction, a direction from the second portion to the second other portion being along the first direction, a second direction from the second conductive pillar to the first conductive pillar crossing the first direction, a direction from the first resonating portion to the second resonating portion being along the second direction;
a first strip line electrically connected to the second portion and the first intermediate portion, the first strip line being along the second direction; and
a second strip line electrically connected to the second other portion and the second intermediate portion, the second strip line being along the second direction.

10. The connection structure according to claim 9, wherein
the first conductive pillar is configured to be electrically connected to a first conductive layer included in the first resonating portion.

11. The connection structure according to claim 1, wherein
a plurality of the first structures are provided, and
a third direction from one of the plurality of the first structures to another one of the plurality of the first structures crosses a plane including the first direction and the second direction.

12. The connection structure according to claim 11, further comprising:
a first connection conductive layer,
the first connection conductive layer is along the third direction, and
the first connection conductive layer electrically connects the plurality of first structures.

13. The connection structure according to claim 11, wherein
a pitch of the plurality of first structures in the third direction is 0.11 times or less a wavelength of a signal to propagate through the first resonating portion.

14. The connection structure according to claim 1, wherein
a first distance in the second direction between a first center in the second direction of the first conductive pillar and a second center in the second direction of the second conductive pillar is not less than 0.07 times and not more than 0.12 times a wavelength of a signal to propagate through the first resonating portion.

15. The connection structure according to claim 7, wherein
a first position of the first conductive pillar in the second direction is between a second position of the second conductive pillar in the second direction and a third position of the third conductive pillar in the second direction,
a fourth position of the fourth conductive pillar in the second direction is between the second position and the third position, and
a distance between the first conductive pillar and the fourth conductive pillar is ¼ or less of a wavelength of a signal to propagate through the first resonating portion.

16. The connection structure according to claim 3, wherein
a part of the plurality of first resonating portion conductive pillars is arranged along the second direction,
another part of the plurality of first resonating portion conductive pillars is arranged along the second direction, and
a direction from the part of the plurality of first resonating portion conductive pillars to the other part of the plurality of first resonating portion conductive pillars is along a third direction crossing a plane including the first direction and the second direction.

17. The connection structure according to claim 3, wherein
the second conductive layer is configured to be electrically connected to the first conductive layer, and
the second opposing conductive layer is configured to be electrically connected to the first opposing conductive layer.

18. A connection structure configured to be provided between a first resonating portion and a second resonating portion,
the connection structure comprising a first structure including a first conductive loop,
the first conductive loop being along a first direction and a second direction crossing the first direction, and
a direction from the first resonating portion to the second resonating portion being aligned along the second direction.

19. A waveguide, comprising:
a first conductive layer;
a second conductive layer, a direction from the first conductive layer to the second conductive layer being along a first direction;
a plurality of first waveguide portion conductive pillars electrically connected to the first conductive layer and the second conductive layer;
a plurality of second waveguide portion conductive pillars electrically connected to the first conductive layer and the second conductive layer; and
a plurality of first structures,
a direction from the plurality of first waveguide portion conductive pillars to the plurality of second waveguide portion conductive pillars being along a second direction crossing the first direction,
the plurality of first waveguide portion conductive pillars being arranged along a third direction crossing a plane including the first direction and the second direction,
the plurality of second waveguide portion conductive pillars being arranged along the third direction,
the plurality of first structures being aligned along the third direction,
one of the plurality of first structures including:
a first conductive pillar including a first portion and a first other portion, the first conductive pillar being along the first direction, a direction from the first portion to the first other portion being along the first direction;
a second conductive pillar including a second portion and a second other portion, the second conductive pillar being along the first direction, a direction from the second portion to the second other portion being along the first direction, a direction from the second conductive pillar to the first conductive pillar being along the second direction; and
a first strip line electrically connected to the first other portion and the second other portion, the first strip line being along the second direction,
the first conductive pillar being electrically connected to at least one of the first conductive layer or the second conductive layer.

20. The waveguide portion according to claim 19, wherein
the second conductive pillar is electrically connected to at least one of the first conductive layer or the second conductive layer.
